(19) United States
(12) Patent Application Publication
(10) Pub. No.: US 2025/0109003 A1
(43) Pub. Date: Apr. 3, 2025

(54) CARGO HANDLING SYSTEM

(71) Applicant: KABUSHIKI KAISHA TOYOTA JIDOSHOKKI, Kariya-shi (JP)

(72) Inventor: Hirokazu Kishida, Kariya-shi (JP)

(73) Assignee: KABUSHIKI KAISHA TOYOTA JIDOSHOKKI, Kariya-shi (JP)

(21) Appl. No.: 18/903,488

(22) Filed: Oct. 1, 2024

(30) Foreign Application Priority Data
Oct. 3, 2023 (JP) 2023-172248

(51) Int. Cl. B66F 9/075; G06V 20/52

(52) U.S. Cl. CPC B66F 9/0755; G06V 20/52

(57) ABSTRACT

A cargo handling system includes an industrial vehicle, a work site where the industrial vehicle performs cargo handling operation and that has a stopping area where the transport vehicle stops, a monitoring unit that monitors at least one of a loading platform and a surrounding area of the loading platform, a determination unit that determines a state of the loading platform and a state of the surrounding area of the loading platform based on information acquired by the monitoring unit; and an instruction unit that transmits an instruction to the industrial vehicle based on a result of determination by the determination unit. The monitoring unit includes an image acquisition at a position different from the industrial vehicle in the work site, the image acquisition unit acquiring an image of at least one of the loading platform of the transport vehicle and the surrounding area of the loading platform.

### CROSS-REFERENCE TO RELATED APPLICATION

This application claims priority to Japanese Patent Application No. 2023-172248 filed on Oct. 3, 2023, the entire disclosure of which is incorporated herein by reference.

The present disclosure relates to a cargo handling system.

### BACKGROUND ART

Japanese Patent Application Publication No. 2021-195215 discloses an example of a conventional cargo handling system. In this conventional cargo handling system, an industrial vehicle such as a forklift truck performs cargo handling operation to a transport vehicle. The cargo handling system includes a device that measures a distance, as a ground equipment. The cargo handling system measures a distance to a pallet on a loading platform, and transmits instructions related to cargo handling to the industrial vehicle based on the distance information.

In the above-mentioned conventional cargo handling system, the ground equipment includes a distance measuring unit that measures a distance. However, based on the distance alone, states of the transport vehicle and its surrounding area may not be sufficiently grasped. In this case, an operator on-site has to make various determinations. Alternatively, a high-performance detection device has to be provided to each industrial vehicle, which increases the cost of the cargo handling system.

The present disclosure has been made to solve the above-mentioned problems, and is directed to providing a cargo handling system that reduces the cost of the cargo handling system.

### SUMMARY

In accordance with an aspect of the present disclosure, there is provided a cargo handling system in which an industrial vehicle performs cargo handling operation to a transport vehicle. The cargo handling system includes the industrial vehicle, a work site where the industrial vehicle performs cargo handling operation, the work site having a stopping area where the transport vehicle stops, a monitoring unit configured to monitor at least one of a loading platform and a surrounding area of the loading platform when the transport vehicle stops at the stopping area, a determination unit configured to determine a state of the loading platform and a state of the surrounding area of the loading platform based on information acquired by the monitoring unit, and an instruction unit configured to transmit an instruction to the industrial vehicle based on a result of determination by the determination unit. The monitoring unit includes an image acquisition unit at a position different from the industrial vehicle in the work site, the image acquisition unit acquiring an image of at least one of the loading platform of the transport vehicle and the surrounding area of the loading platform.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a side view illustrating an example of an industrial vehicle of a cargo handling system according to the present disclosure;

FIG. 2 is a plan view illustrating an example of the cargo handling system;

FIG. 3 is a front view illustrating an example of the cargo handling system;

FIG. 4 is a block diagram illustrating a configuration of the cargo handling system;

FIG. 5 is an image showing a state in which a determination unit makes a determination using artificial intelligence;

FIG. 6 is a flowchart showing an example of processing of the cargo handling system;

FIG. 7 is a flowchart showing the example of processing of the cargo handling system;

FIG. 8 is a flowchart showing the example of processing of the cargo handling system;

FIG. 9 is a flowchart showing the example of processing of the cargo handling system;

FIG. 10 is a flowchart showing the example of processing of the cargo handling system;

FIG. 11 is a flowchart showing an example of processing of the cargo handling system;

FIG. 12 is a flowchart showing the example of processing of the cargo handling system; and

FIG. 13 is a flowchart showing the example of processing of the cargo handling system.

### DETAILED DESCRIPTION OF THE EMBODIMENTS

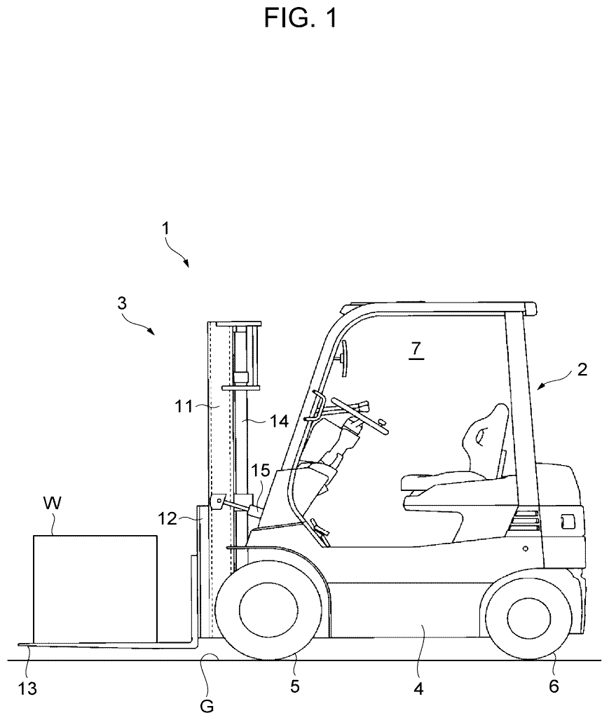

FIG. 1 is a side view illustrating an example of an industrial vehicle 1 according to the present disclosure. The industrial vehicle 1 is a vehicle that performs loading and unloading of cargos W from a transport vehicle. A forklift truck is used as the industrial vehicle 1. The forklift truck is not limited to any particular type, and may be a reach type or a counter type. As illustrated in FIG. 1, the industrial vehicle 1 includes a travelling device 2, a cargo handling device 3 that is disposed in front of the travelling device 2 and has forks 13, and a traveling control unit that controls traveling of the industrial vehicle 1.

The travelling device 2 includes a vehicle body 4, front wheels 5, which are a pair of drive wheels disposed at the front of the vehicle body 4, and rear wheels 6, which are a pair of steered wheels disposed at the rear of the vehicle body 4. The vehicle body 4 includes an operator's cab 7 formed of a frame including a head guard. A lift operation lever used to operate a lift cylinder 14, a tilt operation lever used to operate a tilt cylinder 15, a steering wheel for steering the industrial vehicle 1, and the like, are provided in the operator's cab 7. In addition, the travelling device 2 includes a travelling motor that rotates the front wheels 5, and a steering motor that steers the rear wheels 6 by rotating a steering shaft of the industrial vehicle 1. The travelling device 2 causes the travelling motor to rotate the front wheels 5, and the steering motor to steer the rear wheels 6, thereby causing the industrial vehicle 1 to travel.

The cargo handling device 3 includes a mast 11 attached to the front of the vehicle body 4, a pair of forks 13 attached to the mast 11 via a lift bracket 12 and holding a cargo W, the lift cylinder 14 for moving the forks 13 up and down, and the tilt cylinder 15 for tilting the mast 11. The forks 13 are attached to the lift bracket 12 so as to protrude forward from the lift bracket 12.

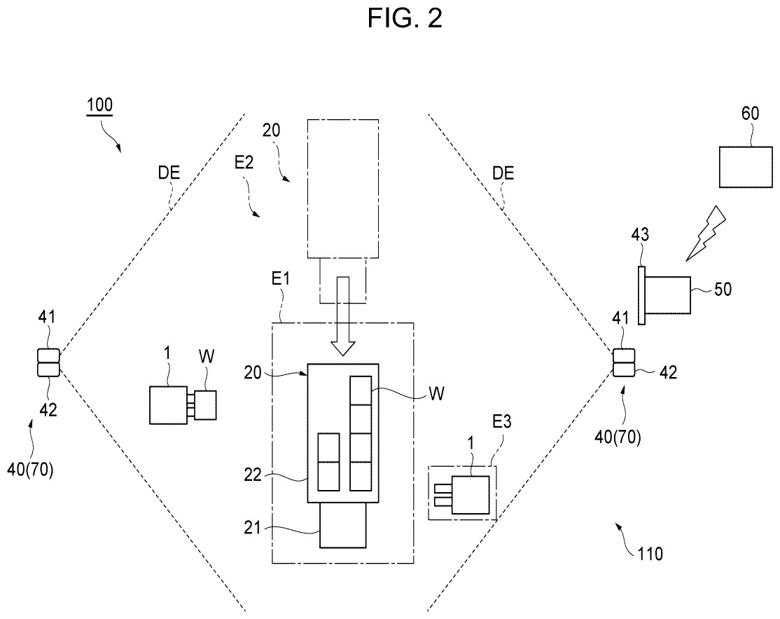

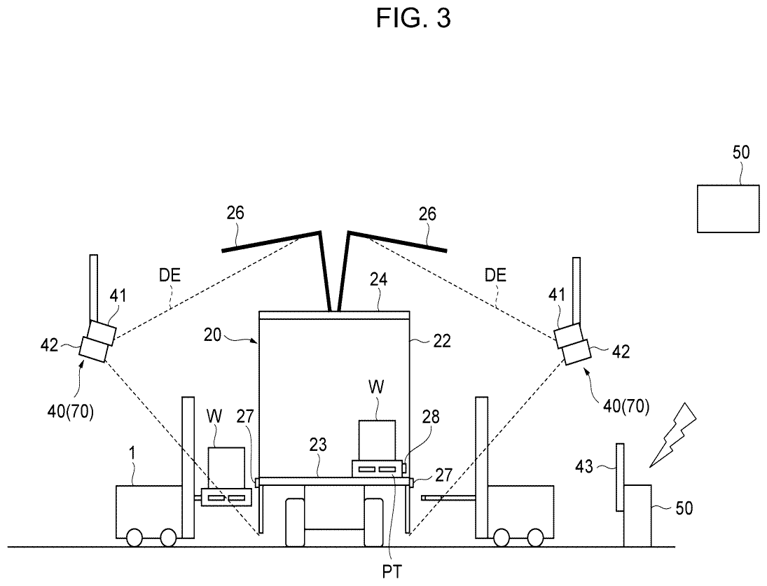

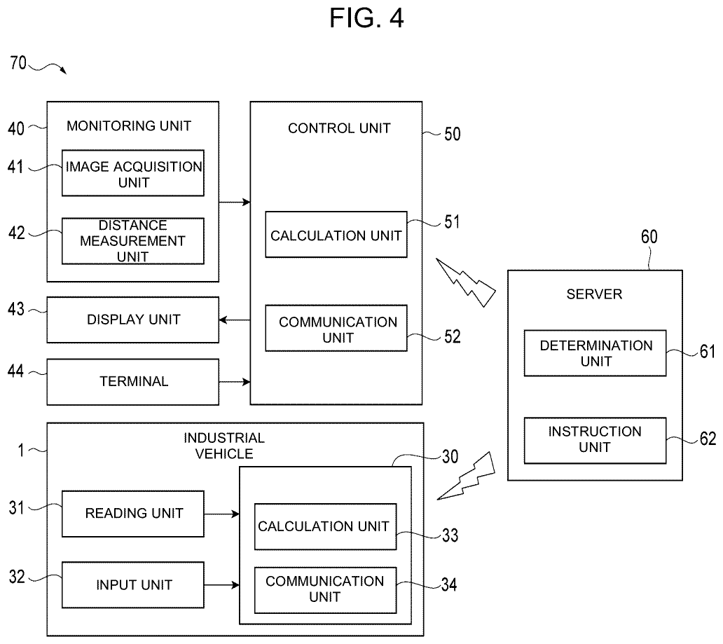

Next, the configuration of the cargo handling system 100 will be described with reference to FIGS. 2 to 4. FIG. 2 is a plan view of the cargo handling system 100. FIG. 3 is a front view of the cargo handling system 100. FIG. 4 is a block diagram of the cargo handling system 100. As illustrated in FIGS. 2 and 3, the cargo handling system 100 includes the above-mentioned industrial vehicle 1, a transport vehicle 20, a work site 110, a ground equipment 70, and a server 60. The cargo handling system 100 is a system in which the industrial vehicle 1 performs cargo handling operation to the transport vehicle 20.

As illustrated in FIG. 4, the industrial vehicle 1 includes a control unit 30, a reading unit 31, and an input unit 32. The control unit 30 is a device that controls the entire industrial vehicle 1. The control unit 30 includes a CPU, a RAM, a ROM, input/output interfaces, and the like. The control unit 30 includes a calculation unit 33 that performs various calculations, and a communication unit 34 that performs communication. The communication unit 34 communicates with the ground equipment 70 and the server 60. The reading unit 31 is a device capable of reading various types of information. The reading unit 31 reads identification information from identification information providing units 27, 28 which will be described later. The reading unit 31 may include an image acquisition unit such as a camera, an RFID reader that reads an RFID tag, and the like. A position of the reading unit 31 in the industrial vehicle 1 is not limited to any particular position as long as the identification information providing units 27, 28 can be read by the reading unit 31. The input unit 32 is a device on which various types of information can be input to the industrial vehicle 1. The input unit 32 includes various switches, a touch panel, and the like.

As illustrated in FIG. 2, the transport vehicle 20 includes a travel unit 21 and a loading platform 22 on which cargos W are loaded. In the present embodiment, a truck is used as the transport vehicle 20. As illustrated in FIG. 3, the loading platform 22 includes a floor portion 23, a ceiling portion 24, and a pair of wings 26. The pair of wings 26 opens and closes side portions of the loading platform 22. The wings 26 open and close using the ceiling portion 24 as a hinge. Pallets PT on which the cargos W are placed are loaded on the floor portion 23 of the loading platform 22.

The identification information providing unit 27 that provides identification information for identifying the transport vehicle 20 is provided in the loading platform 22. The identification information providing unit 28 that provides identification information for identifying the cargos W on each pallet PT is provided in the corresponding pallet PT For example, a medium that can be read based on an image may be used as the identification information providing units 27, 28. For example, the identification information providing units 27, 28 each may be a QR code (registered trademark), a bar code, or the like. Alternatively, the identification information providing units 27, 28 may be a medium that can be read by a reading device. For example, an RFID tag or the like may be used as the medium that can be read by a reading device. The identification information providing units 27, 28 are read by the reading unit 31 (see FIG. 4) provided on the industrial vehicle 1.

As illustrated in FIG. 2, the work site 110 has a stopping area E1, a waiting place E2, and a home position E3. The stopping area E1 is an area where the transport vehicle 20 stops. The industrial vehicle 1 performs unloading of the cargos W loaded on the loading platform 22 of the transport vehicle 20 stopped in the stopping area E1. The waiting place E2 is an area where the transport vehicle waits. At the waiting place E2, the transport vehicle 20 waits until the stopping area E1 becomes available for stopping. The home position E3 is an area where the industrial vehicle 1 waits when the industrial vehicle 1 does not perform the cargo handling operation.

The ground equipment 70 is a device provided at a position different from the industrial vehicle 1 and the transport vehicle 20 in the work site 110. That is, the ground equipment 70 is not mounted on the industrial vehicle 1 or the transport vehicle 20, but is provided as a device on a facility side. The ground equipment 70 includes monitoring units 40 and a control unit 50.

The monitoring units 40 each monitor at least one of the loading platform 22 of the transport vehicle 20 stopped at the stopping area E1 and a surrounding area of the loading platform 22 stopped at the stopping area E1. The monitoring units 40 each includes an image acquisition unit 41 that acquires an image of at least one of the loading platform 22 of the transport vehicle 20 and the surrounding area of the loading platform 22, and a distance measurement unit 42 that measures the distance to a target object. The monitoring unit 40 has a monitoring area DE. The monitoring area DE includes the stopping area E1, the waiting place E2, and the home position E3. In the present embodiment, the cargo handling system 100 has a pair of monitoring units 40. One of the monitoring units 40 monitors one side of the transport vehicle 20. The other of the monitoring units 40 monitors the other side of the transport vehicle 20. Although positions of the monitoring units 40 are not limited to any particular positions, the monitoring units 40 are disposed at positions spaced above the ground so as to monitor the sides of the transport vehicle 20 entirely and the surroundings of the transport vehicle 20, as illustrated in FIG. 3. The image acquisition unit 41 is a device that acquires an image within the monitoring area DE. The image acquisition unit 41 is, for example, a camera. The distance measurement unit 42 is a device that measures a distance to the target object existing in the monitoring area DE. The distance measurement unit 42 is, for example, a 3D LIDAR, or the like.

The control unit 50 is a device that controls the entire ground equipment 70. The control unit 50 includes a CPU, a RAM, a ROM, input/output interfaces, and the like. The control unit 50 may be disposed at any position in the work site 110 that does not disturb cargo handling operation. As illustrated in FIG. 4, the control unit 50 includes a calculation unit 51 that performs various calculations, and a communication unit 52 that performs communication. The communication unit 52 can communicate with the industrial vehicle 1 and the server 60.

As illustrated in FIG. 4, the ground equipment 70 includes a display unit 43 and a terminal 44. The display unit 43 is a device that receives display information from the control unit 50 to display such display information in the work site 110. The display unit 43 may be a monitor, a touch panel, or the like. The display unit 43 only needs to be provided at the position of the control unit 50 (see FIGS. 2 and 3), or only needs to be provided at any position in the work site 110. The display unit 43 displays information such as whether cargo handling operation can be started, temporary halt of the cargo handling operation, or ending of the cargo handling operation. The terminal 44 is a device on which an operator can input information in the work site 110. The terminal 44 transmits input information to the control unit 50. The terminal 44 may be a dedicated operation terminal, a tablet, a smartphone, or the like. The terminal 44 can accept button operations to indicate an intention to start an automated operation or an intention to resume the automated operation.

The server 60 executes various types of information processing in the cargo handling system 100 and accumulates various types of information. The server 60 may be provided on the work site 110, or may be provided outside the work site 110. The server 60 may be a cloud server, or the like. As illustrated in FIG. 4, the server 60 includes a determination unit 61 and an instruction unit 62. The determination unit 61 determines a state of the loading platform 22 and a state of the surrounding area of the loading platform 22 based on the information acquired by the monitoring units 40. The determination unit 61 makes a determination using artificial intelligence. The artificial intelligence is trained based on data in which past monitoring information from the monitoring unit 40 is linked with a state corresponding to the past monitoring information. For example, the artificial intelligence is trained from image data acquired by the monitoring units 40. The instruction unit 62 transmits an instruction to the industrial vehicle 1 based on a result of the determination by the determination unit 61. There is no particular limitation as to where the determination unit 61 and the instruction unit 62 are provided in the cargo handling system 100, and the determination unit 61 and the instruction unit 62 may be provided in the control unit 50, or in the ground equipment 70 other than the control unit 50.

The determination unit 61 makes a determination related to the cargo handling operation. Specifically, the determination unit 61 determines whether or not the transport vehicle 20 is present in the stopping area E1 and the waiting place E2. The determination unit 61 determines the position of the transport vehicle 20 in each of the areas E1 and E2. The determination unit 61 determines whether the wings 26 of the transport vehicle 20 are opened or closed. The determination unit 61 determines whether or not an obstacle is present on the loading platform 22. The determination unit 61 determines a height of the loading platform of the transport vehicle 20. In the following description, the determination related to a state of the transport vehicle 20 may be referred to as “determination of the state of the transport vehicle 20.” In addition, the determination unit 61 determines whether or not an obstacle (a person such as an operator) is present in the surrounding area of the transport vehicle 20. For these determination contents, the determination unit 61 may make a determination using both of the image data and the distance data, but may be configured to make a determination only from the image data using artificial intelligence or the like. Based on these results of determination, the instruction unit 62 issues an instruction for the cargo handling operation to the industrial vehicle 1. The instruction unit 62 issues an instruction regarding positions where cargos are placed, an order of loading and unloading, the number of cargos, and the like. Furthermore, when the determination unit 61 determines that a person is present in the surrounding area of the loading platform 22, the instruction unit 62 transmits a stop instruction to the industrial vehicle 1. The determination unit 61 also determines information relating to a state of the cargo handling operation. For example, the determination unit 61 determines whether or not the cargo handling operation can be started and whether or not the cargo handling operation has been completed.

The determination unit 61 may determine a destination based on the identification information of the pallets PT. The instruction unit 62 issues an instruction for a place where the cargos W are to be placed. The determination unit 61 determines a shape of the pallet PT based on sizes of pallet holes included in the identification information, and the instruction unit 62 issues an instruction indicating an optimal distance between the forks. The server 60 may manage information regarding which and how many cargos Ware loaded on which transport vehicle 20 based on the identification information of the transport vehicle 20 and the identification information of the pallets PT. The determination unit 61 may determine which transport vehicle 20 stops at the stopping area E1 based on the identification information of the transport vehicle 20, and identify the cargos W from the information managed by the server 60. Then, the instruction unit 62 issues an instruction for an unloading destination to cause the industrial vehicle 1 to perform the automated operation. The instruction unit 62 also issues an instruction relating to a designated pallet, a location of loading, a loading order, and the number of pallets to cause the industrial vehicle 1 to perform the automated operation.

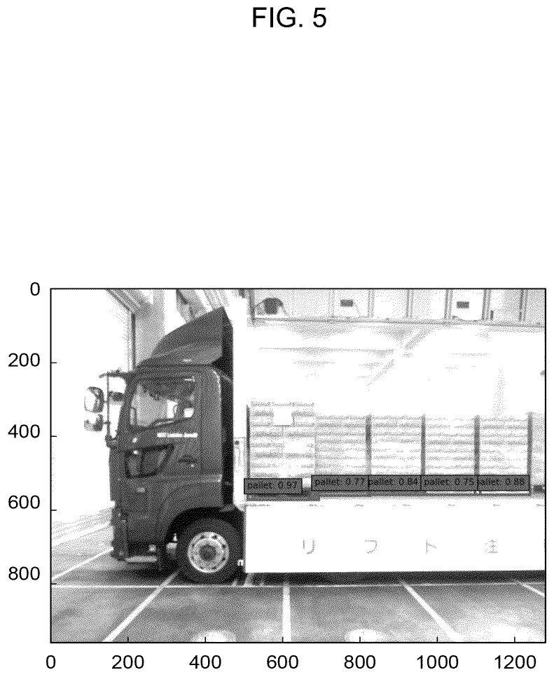

For example, as shown in FIG. 5, the determination unit 61 determines the number of pallets on the loading platform 22 from image data of the loading platform 22 sent from the monitoring unit 40 by a known technique using trained artificial intelligence. The instruction unit 62 transmits the number of the pallets determined by the determination unit 61 to the industrial vehicle 1. This allows the industrial vehicle 1, which performs the automated operation, to determine an operation amount for loading and unloading. Furthermore, if the pallets PT are stacked vertically, the determination unit 61 may determine whether an upper pallet PT or a lower pallet PT is to be loaded or unloaded. In addition, by using a technique for determining the pallet PT using artificial intelligence, the determination unit 61 may determine the presence or absence of a person, the presence or absence of the transport vehicle 20, the position of the transport vehicle 20, the height of the loading platform, and the like, based on the image data.

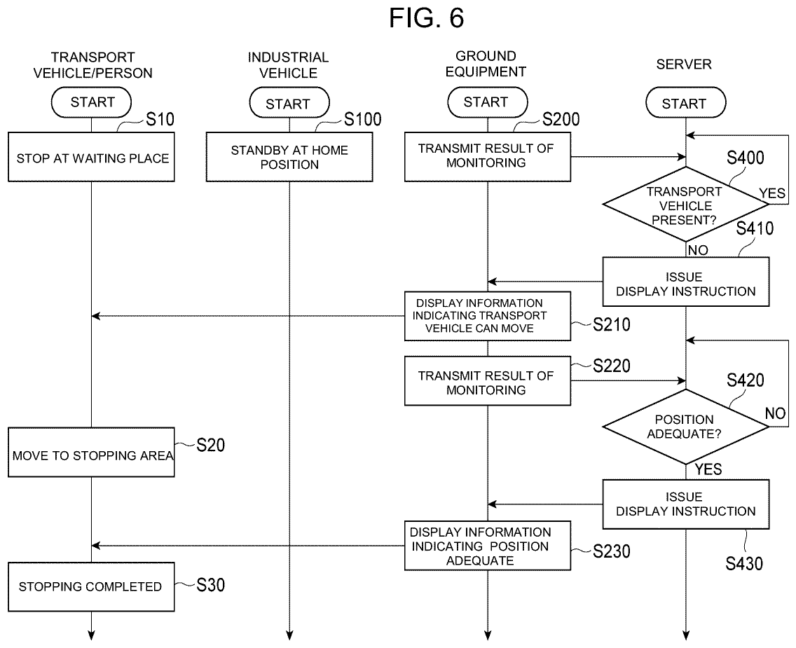

Next, an example of processing executed by the cargo handling system 100 will be described with reference to FIGS. 6 to 13. In the flowchart, operations of “TRUCK (transport vehicle 20)/PERSON,” “INDUSTRIAL VEHICLE,” “GROUND EQUIPMENT,” and “SERVER” are listed in parallel. Firstly, details of processing when the cargos W are loaded and unloaded from the transport vehicle 20 by the automated operation of the industrial vehicle 1 will be described with reference to FIGS. 6 to 10.

At a start of processing in FIG. 6, the transport vehicle 20 stops at the waiting place E2 (step S10). The industrial vehicle 1 is on standby at the home position E3 (step S100). The monitoring unit 40 of the ground equipment 70 transmits a result of monitoring to the server 60 (step S200). The determination unit 61 of the server 60 determines whether or not the transport vehicle 20 is present in the stopping area E1 (step S400). When the determination unit 61 determines that the transport vehicle 20 is present, the determination unit 61 performs step S400 again. When the determination unit 61 determines that the transport vehicle 20 is not present, the instruction unit 62 issues a display instruction to the display unit 43 of the ground equipment 70 (step S410). The display unit 43 displays information for a driver of the transport vehicle 20, indicating that the transport vehicle 20 can move to the stopping area E1 (step S210). When the determination unit 61 determines in step S400 that the transport vehicle 20 is in the stopping area E1, the display unit 43 may display information indicating that the transport vehicle 20 cannot move to the stopping area E1. The transport vehicle moves to the stopping area E1 at any timing after the information is displayed (step S20).

The monitoring unit 40 transmits the result of monitoring to the server 60 (step S220). The determination unit 61 determines whether the position of the transport vehicle 20 in the stopping area E1 is adequate (step S420). When the determination unit 61 determines that the position of the transport vehicle 20 is not adequate, the determination unit 61 performs step S420 again. When the determination unit 61 determines that the position of the transport vehicle 20 is adequate, the instruction unit 62 issues a display instruction to the display unit 43 (step S430). The display unit 43 displays information for the driver of the transport vehicle 20, indicating that the position of the transport vehicle 20 in the stopping area E1 is adequate (step S230). When the determination unit 61 determines in step S420 that the position of the transport vehicle 20 is not adequate, the display unit 43 may display information, indicating that the position of the transport vehicle 20 is not adequate. After the information indicating that the position of the transport vehicle 20 in the stopping area E1 is adequate is displayed, stopping of the transport vehicle 20 is completed (step S30).

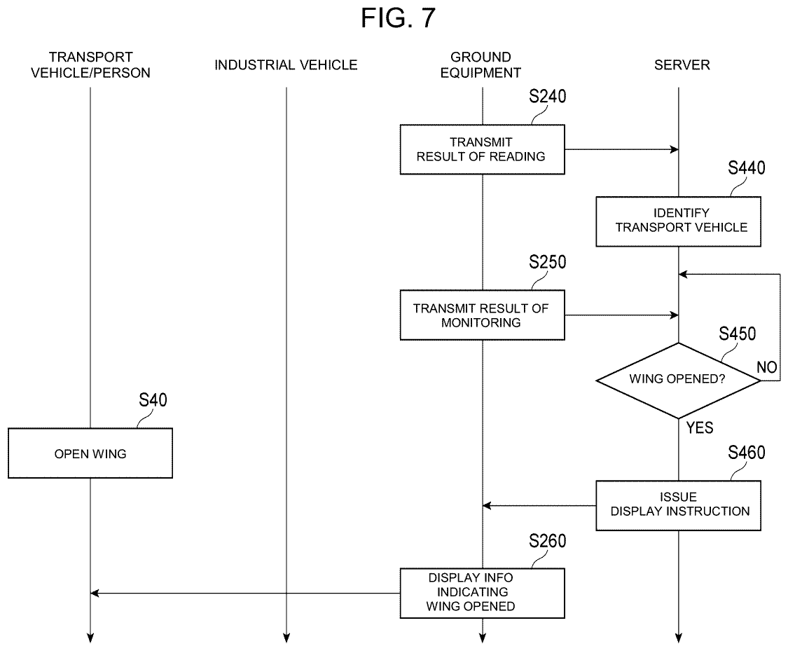

As shown in FIG. 7, the monitoring unit 40 reads the identification information of the identification information providing unit 27 of the transport vehicle 20, and transmits a result of reading to the server 60 (step S240). The determination unit 61 identifies the transport vehicle 20 based on the result of reading (step S440). The transport vehicle 20 opens the wings 26 at any timing after the transport vehicle 20 stops (step S40). The monitoring unit 40 transmits the result of monitoring to the server 60 (step S250). The determination unit 61 determines whether or not the wings 26 of the transport vehicle 20 are opened (step S450). When the determination unit 61 determines that the wings 26 are closed, the determination unit 61 performs step S450 again. When the determination unit 61 determines that the wings 26 are opened, the instruction unit 62 issues a display instruction to the display unit 43 of the ground equipment 70 (step S460). The display unit 43 displays information for the driver of the transport vehicle 20, indicating that the wings 26 are opened (step S260). If the determination unit 61 determines in step S450 that the wings 26 are closed, the display unit 43 may display information, indicating that the wings 26 are closed.

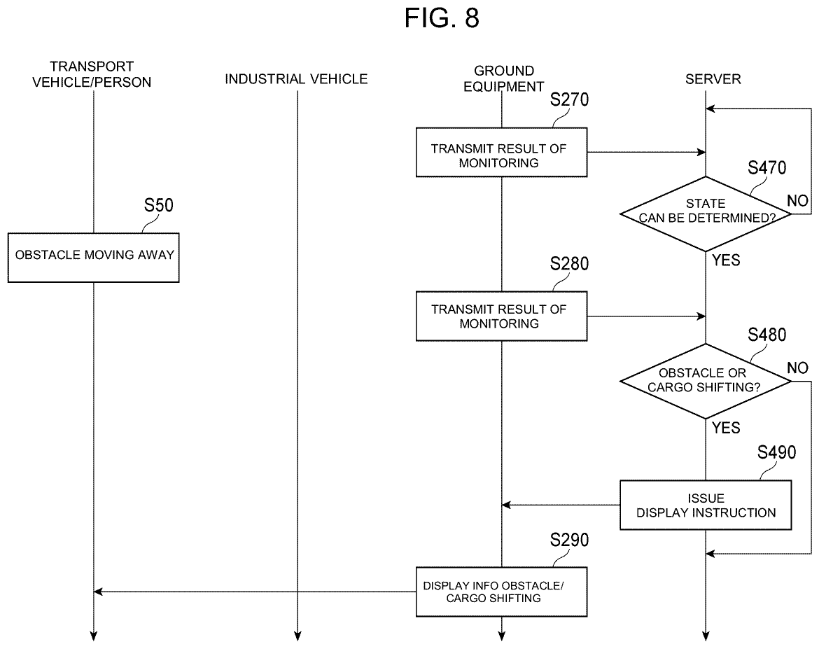

As shown in FIG. 8, the monitoring unit 40 transmits the result of monitoring (step S270). The determination unit 61 makes a determination on various conditions relating to the determination of the state of the transport vehicle 20, and on whether or not the state of the transport vehicle 20 can be determined (step S470). An obstacle such as a person may move away from the surrounding area of the transport vehicle 20 at any time after the wings 26 are opened (step S50). When the determination unit 61 determines that the state of the transport vehicle cannot be determined, the determination unit 61 repeats step S470 until the state of the transport vehicle 20 can determined. The monitoring unit 40 transmits the result of monitoring to the server 60 (step S280). The determination unit 61 determines whether or not an obstacle is present in the surrounding area of the transport vehicle 20 and whether or not there is a possibility of cargo shifting (step S480). When the determination unit 61 determines that an obstacle is present or there is a possibility of cargo shifting, the instruction unit 62 issues a display instruction to the display unit 43 of the ground equipment 70 (step S490). The display unit 43 displays information for the driver of the transport vehicle 20, indicating that an obstacle is present or there is a possibility of cargo shifting (step S290). After the display in step S290, waiting may be performed until the obstacle moves away and there is no longer possibility of cargo shifting by performing step S480 again. It is noted that step S490 is omitted when the determination unit 61 determines in step S480 that an obstacle is not present and there is no possibility of cargo shifting.

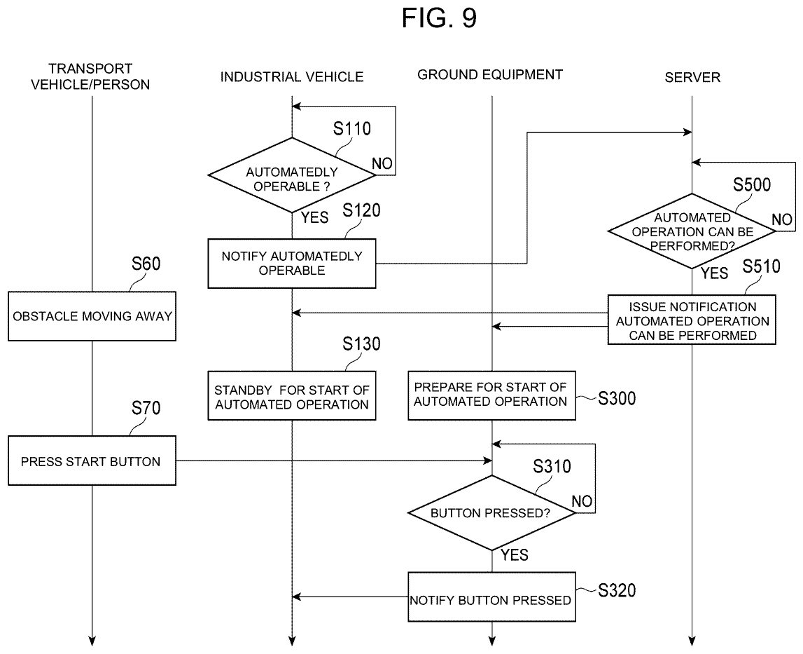

As shown in FIG. 9, the industrial vehicle 1 determines whether or not the industrial vehicle 1 itself is in an automatedly operable state in which the industrial vehicle 1 can perform the automated operation (step S110). When the industrial vehicle 1 is not in the automatedly operable state, step S110 is performed again. When the industrial vehicle 1 is in the automatedly operable state, the industrial vehicle 1 notifies the server 60 as such (step S120). Meanwhile, the determination unit 61 determines whether or not the industrial vehicle 1 can perform the automated operation (step S500). When the determination unit 61 determines that the industrial vehicle 1 cannot perform the automated operation, the determination unit 61 performs step S500 again. After receiving notification of step S120, the determination unit 61 determines that the industrial vehicle 1 can perform the automated operation in step S500. At this time, the instruction unit 62 issues notification indicating that the automated operation can be performed to the industrial vehicle 1 and the ground equipment 70 (step S510). In addition, the instruction unit 62 transmits instruction data necessary for the automated operation to the industrial vehicle 1 in step S510. After receiving the notification, the industrial vehicle 1 becomes in a standby state for the automated operation (step S130). An obstacle may move away from the surrounding area of the transport vehicle 20 at any time after the display unit 43 displays information, indicating that an obstacle is present or there is a possibility of cargo shifting after the wings 26 are opened (step S60). The ground equipment 70 prepares for a start of the automated operation by displaying a button “Start automated operation” on the terminal 44 and starting to accept pressing of the button (step S300). The operator presses the button at any time after this processing (step S70). The ground equipment 70 determines whether or not the button has been pressed (step S310). When the ground equipment 70 determines that the button has not been pressed, the ground equipment 70 performs step S310 again. When the ground equipment 70 determines that the button has been pressed, the ground equipment 70 notifies the industrial vehicle 1 that the button has been pressed (step S320).

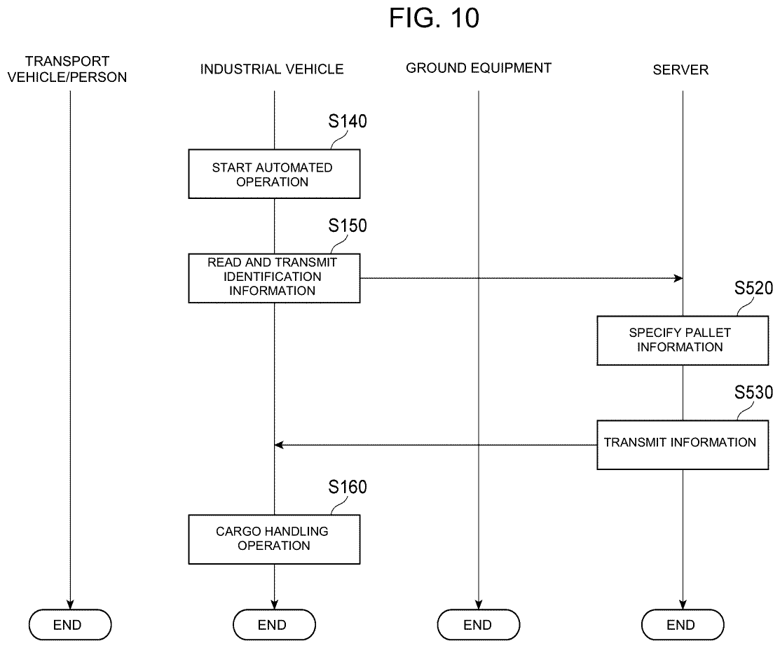

As shown in FIG. 10, the industrial vehicle 1 starts the automated operation based on the instruction data received in step S510 (step S140). The industrial vehicle 1 reads the identification information from the identification information providing unit 28 provided in the pallet PT, and transmits the identification information to the server 60 (step S150). The determination unit 61 specifies pallet information such as a shipper, a type of cargos, a weight of cargos, a destination, and sizes of the pallet holes based on the identification information (step S520). The determination unit 61 determines the loading and unloading positions and the distance between the forks, and the instruction unit 62 transmits such information to the industrial vehicle 1 (step S530). The industrial vehicle 1 performs the cargo handling operation based on the information received in step S530 (step S160). Accordingly, the processing shown in FIGS. 6 to 10 ends.

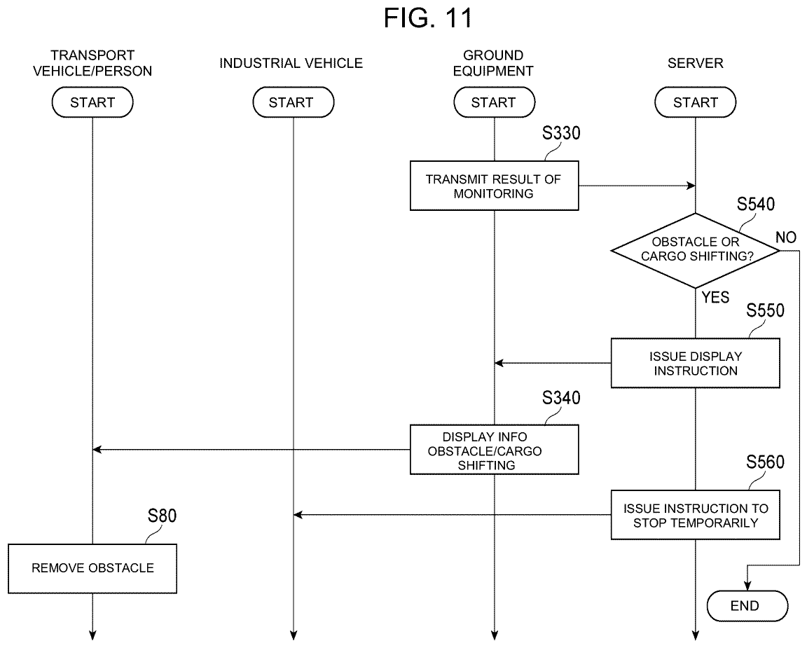

The following will describe processing to temporarily stop the automated operation of the industrial vehicle 1 during the automated operation when an obstacle enters the surrounding area of the transport vehicle 20 and when there is a possibility of cargo shifting, with reference to FIGS. 11 to 13. As shown in FIG. 11, the monitoring unit 40 transmits the result of monitoring to the server 60 (step S330). The determination unit 61 determines whether or not an obstacle is present in the surrounding area of the transport vehicle 20 and whether or not there is a possibility of cargo shifting (step S540). When the determination unit 61 determines that no obstacle is present and that there is no possibility of the cargo shifting, the processing shown in FIGS. 11 to 13 ends, and step S330 is performed again. If the determination unit 61 determines that an obstacle is present and/or there is a possibility of cargo shifting, the instruction unit 62 issues a display instruction to the display unit 43 of the ground equipment 70 (step S550). The display unit 43 displays information for an operator, indicating that an obstacle is present and/or there is a possibility of cargo shifting (step S340). Furthermore, the instruction unit 62 issues an instruction to the industrial vehicle 1 to stop temporarily (step S560). At any time during this period, the operator removes the obstacle (step S80).

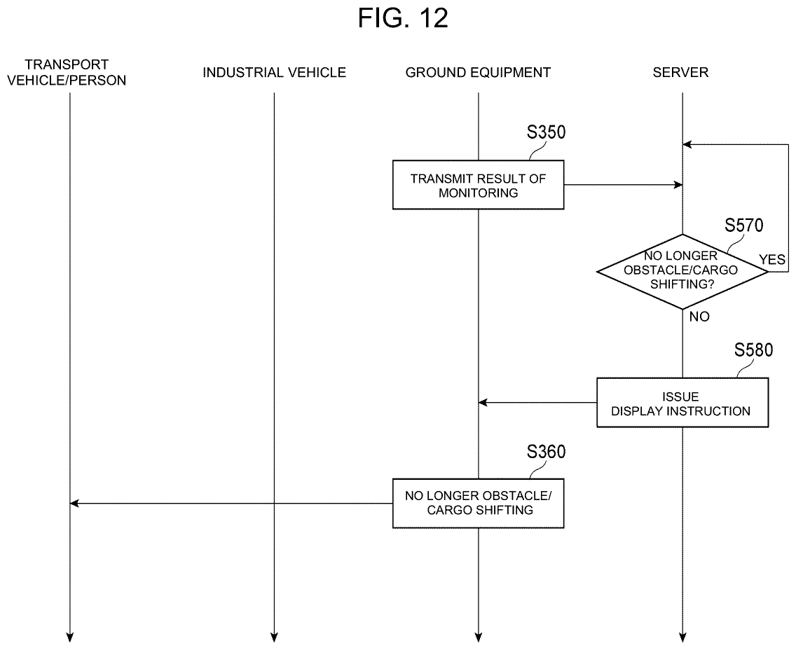

As shown in FIG. 12, the monitoring unit 40 transmits the result of monitoring to the server 60 (step S350). The determination unit 61 determines whether or not an obstacle is no longer present in the surrounding area of the transport vehicle 20 and there is no longer any possibility of the cargo shifting (step S570). When the determination unit 61 determines that an obstacle is present and/or that there is a possibility of the cargo shifting, the determination unit 61 performs step S570 again. When the determination unit 61 determines that an obstacle is no longer present and/or there is no longer any possibility of the cargo shifting, the instruction unit 62 issues a display instruction to the display unit 43 of the ground equipment 70 (step S580). The display unit 43 displays information for the operator, indicating that an obstacle is no longer present and/or there is no longer any possibility of the cargo shifting (step S360).

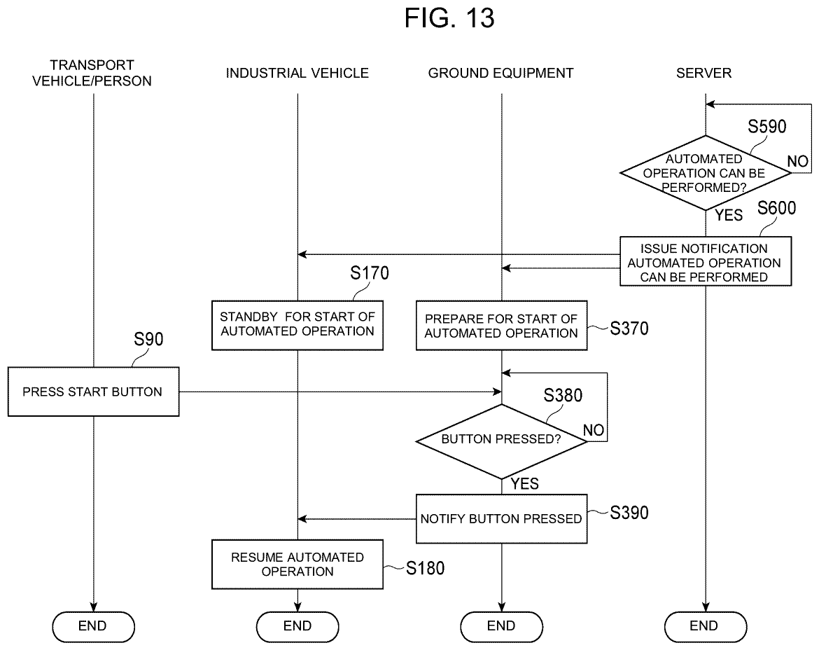

As shown in FIG. 13, the determination unit 61 determines whether or not the industrial vehicle 1 can perform the automated operation (step S590). When the determination unit 61 determines that the industrial vehicle 1 cannot perform the automated operation, the determination unit 61 performs step S590 again. When the determination unit 61 determines that the industrial vehicle 1 can perform the automated operation, the instruction unit 62 issues notification indicating that the automated operation can be performed to the industrial vehicle 1 and the ground equipment 70 (step S600). In addition, the instruction unit 62 transmits instruction data necessary for the automated operation to the industrial vehicle 1 in step S600. After receiving the notification, the industrial vehicle 1 becomes in a standby state for the automated operation (step S170). The ground equipment 70 prepares for a start of the automated operation by displaying a button “Start automated operation” on the terminal 44 and starting to accept pressing of the button (step S370). The operator presses the button at any timing after this processing (step S90). The ground equipment 70 determines whether or not the button has been pressed (step S380). When the ground equipment 70 determines that the button has not been pressed, the ground equipment 70 performs step S380 again. When the ground equipment 70 determines that the button has been pressed, the ground equipment 70 notifies the industrial vehicle 1 that the button has been pressed (step S390). The industrial vehicle 1 resumes the automated operation based on the instruction data received in step S600 (step S180). Accordingly, the processing shown in FIGS. 11 to 13 ends.

Next, the operation and effects of the cargo handling system 100 according to the present embodiment will be described.

The cargo handling system 100 includes the monitoring unit 40 that monitors at least one of the loading platform 22 of the transport vehicle 20 stopped at the stopping area E1 and the surrounding area of the loading platform 22, and the determination unit 61 that determines the states of the loading platform 22 and the surrounding area of the loading platform 22 based on information acquired by the monitoring unit 40. Here, the monitoring unit 40 is provided at the position in the work site 110 different from the industrial vehicle 1, and includes the image acquisition unit 41 that acquires images. In this way, the monitoring unit 40 can acquire images not from the industrial vehicle 1 but from the image acquisition unit 41 provided on the ground equipment side. Therefore, the determination unit 61 can determine the state of the loading platform 22 and the state of surrounding area of the loading platform 22 based on the image obtained by the image acquisition unit 41 on the ground equipment side. In the cargo handling system 100, a high-performance monitoring unit for the determination unit 61 to make a determination does not have to be provided to each of the industrial vehicles 1. As a result, the cost can be reduced.

For example, in a case where a monitoring unit (camera and LIDAR) for high-performance determination is to be provided for each of two industrial vehicles 1, the industrial vehicles 1 each have to include three monitoring units for three directions, which requires six monitoring units and costs about 900000 yen. On the other hand, in a case where the monitoring unit 40 is installed on the ground equipment side, other than the industrial vehicles 1, two devices are required, which costs about 300000 yen. In addition, a PC (costs approximately 200000 yen) for performing high-performance determination does not have to be installed in each of the industrial vehicles 1. As a result, a total of approximately 800000 yen in cost may be reduced.

The determination unit 61 makes the determination using artificial intelligence. In this case, the determination unit 61 can determine the state of the loading platform 22 of the transport vehicle 20 and the state of the surrounding area of the transport vehicle 20 in more detail based on the acquired image.

Furthermore, when the determining unit 61 determines that a person is present in the surrounding area of the loading platform 22, the instruction unit 62 may transmit a stop instruction to the industrial vehicle 1. In this case, safety when a person is present in the surrounding area of the loading platform 22 can be increased.

The monitoring unit 40 may further include the distance measurement unit 42 that measures the distance to the target object. In this case, the monitoring unit can determine the state of the loading platform 22 of the transport vehicle 20 and the state of the surrounding area of the transport vehicle 20 from both of the image and the distance to the target object.

The present invention is not limited to the above-described embodiment.

For example, the configuration of the cargo handling system including the work site illustrated in FIGS. 2 and 3 is an example, and may be changed as appropriate. The flowcharts shown in FIGS. 6 to 13 are also merely an example, and may be changed as appropriate.

The idea of the present disclosure is described as following [1] to [4].
[1]A cargo handling system in which an industrial vehicle performs cargo handling operation to a transport vehicle, the cargo handling system comprising:
   the industrial vehicle;
   a work site where which the industrial vehicle performs cargo handling operation, the work site having a stopping area where the transport vehicle stops;
   a monitoring unit configured to monitor at least one of a loading platform of the transport vehicle and a surrounding area of the loading platform when the transport vehicle stops at the stopping area;
   a determination unit configured to determine a state of the loading platform and a state of the surrounding area of the loading platform based on information acquired by the monitoring unit; and
   an instruction unit configured to transmit an instruction to the industrial vehicle based on a result of determination by the determination unit, wherein
   the monitoring unit includes an image acquisition unit at a position different from the industrial vehicle in the work site, the image acquisition unit acquiring an image of at least one of the loading platform of the transport vehicle and the surrounding area of the loading platform.
[2] The cargo handling system according to [1], wherein the determination unit makes a determination using artificial intelligence.
[3] The cargo handling system according to [1] or [2], wherein the instruction unit transmits a stop instruction to the industrial vehicle when the determining unit determines that a person is present around the loading platform.
[4] The cargo handling system according to any one of [1] to [3], wherein, the monitoring unit further includes a distance measuring unit that measures a distance to a target object.

What is claimed is:

1. A cargo handling system in which an industrial vehicle performs cargo handling operation to a transport vehicle, the cargo handling system comprising:
the industrial vehicle;
a work site where the industrial vehicle performs cargo handling operation, the work site having a stopping area where the transport vehicle stops;
a monitoring unit configured to monitor at least one of a loading platform of the transport vehicle and a surrounding area of the loading platform when the transport vehicle stops at the stopping area;
a determination unit configured to determine a state of the loading platform and a state of the surrounding area of the loading platform based on information acquired by the monitoring unit; and
an instruction unit configured to transmit an instruction to the industrial vehicle based on a result of determination by the determination unit, wherein
the monitoring unit includes an image acquisition unit at a position different from the industrial vehicle in the work site, the image acquisition unit acquiring an image of at least one of the loading platform of the transport vehicle and the surrounding area of the loading platform.

2. The cargo handling system according to claim 1, wherein the determination unit makes a determination using artificial intelligence.

3. The cargo handling system according to claim 1, wherein
the instruction unit transmits a stop instruction to the industrial vehicle when the determination unit determines that a person is present in the surrounding area of the loading platform.

4. The cargo handling system according to claim 1, wherein
the monitoring unit further includes a distance measuring unit that measures a distance to a target object.
